(19) United States
(12) Patent Application Publication
(10) Pub. No.: US 2022/0412114 A1
(43) Pub. Date: Dec. 29, 2022

(54) AUTOMATED VEHICULAR PARKING APPARATUS

(71) Applicant: Park Plus, Inc., Fairview, NJ (US)

(72) Inventor: Andreas Wastel, Randolph, NJ (US)

(21) Appl. No.: 17/851,866

(22) Filed: Jun. 28, 2022

Related U.S. Application Data
(60) Provisional application No. 63/216,346, filed on Jun. 29, 2021.

(51) Int. Cl. E04H 6/06; E04H 6/42; B66F 7/28; B66F 7/04

(52) U.S. Cl. CPC E04H 6/06; E04H 6/424; B66F 7/28; B66F 7/04

(57) ABSTRACT

A parking apparatus has a parking platform mounted to stanchions for movement between lower and upper positions. Left and right lever assemblies have inner surfaces facing toward one another and outer surfaces facing away from one another. Each lever assembly includes a first lever with an upper end articulated to the parking platform and a lower end articulated to a base. A piston-cylinder assembly moves the lever assemblies to raise or lower the parking platform. The upper end of each lever assembly has an inner bearing rotatably mounted adjacent the inner surface of the respective lever assembly and an outer bearing mounted adjacent a surface of the parking platform facing away from the inner bearing. A pin engages the inner and outer bearings, passes through the upper end of the respective first lever and through a part of the parking platform facing the outer surface of the respective lever assembly.

This application claims priority on U.S. Provisional Application No. 63/216,346 filed on Jun. 29, 2021, the entire disclosure of which is incorporated herein by reference.

### BACKGROUND

### Field of the Invention

The invention relates to an automated parking apparatus that enables two vehicles to parked vertically in a space corresponding to a size of one of the vehicles.

### Description of the Related Art

Urban areas continue to become populated more densely and typically offer fewer spaces for accommodating an increasing population of vehicles. Parking devices have been available for decades to permit two or more vehicles to be parked in a vertical array. An example of one such parking apparatus is disclosed in U.S. Pat. No. 4,772,172, the disclosure of which is incorporated herein by reference.

The parking apparatus disclosed in U.S. Pat. No. 4,772,172 has left and right longitudinal supports that are positioned securely on a horizontal surface. Left and right vertical stanchions extend up from the longitudinal supports. A parking platform is mounted for vertical movement along the stanchions between a lower position and an upper position. The parking platform that is in the lower position is between the left and right longitudinal supports and adjacent the ground surface or floor on which the longitudinal supports are positioned. As a result, a vehicle can drive onto the parking platform. The parking platform with the vehicle mounted thereon then can be elevated along the vertical stanchions and into a position that enables a second vehicle to be parked beneath the parking platform and between the left and right vertical stanchions. A mechanism is provided for selectively raising and lowering the parking platform. The mechanism shown in U.S. Pat. No. 4,772,172 includes left and right arrays of articulated levers and left and right piston-cylinder assemblies. Each array of articulated levers includes a base lever having a first end articulated to a rear position on a respective left or right longitudinal support and a second end opposite the first end. Each array of articulated levers also includes a platform lever having a first end articulated to a position on the parking platform near the respective vertical stanchion and a second end articulated to the second end of the base lever. The cylinder of each piston-cylinder assembly is mounted pivotally to the upper end of a respective one of the stanchions. The piston of each piston-cylinder assembly is mounted to an intermediate position on the respective platform lever between the first and second ends of the respective platform lever. Hydraulic pressure applied in the cylinders will cause the pistons to extend from the cylinders. Hydraulic pressure removed from the cylinders will cause the pistons to be retracted into the cylinders. Movement of the pistons into or out of the respective cylinders causes the parking platform to be raised or lowered.

The weight of the parking platform and the weight of the vehicle on the parking platform is applied directly to the location where the platform lever is connected to the platform. This connection must be a pivotal connection in view of the pivoting of the platform lever relative to the parking platform as the parking platform is raised and lowered. The pivotal connection of the first end of the platform lever to the parking platform is critical to proper functioning of the parking apparatus. A failure of this pivotal connection could damage one or more parked vehicles and could damage the parking apparatus. At a very minimum, a failure of this pivotal connection would disable the parking apparatus until a repair can be completed, thereby adversely affecting the revenue stream of the owner of the parking apparatus.

In view of the above, an object of the invention is to provide a parking apparatus that provides an enhanced and more robust connection of the pivotal connection between the platform lever and the parking platform.

### SUMMARY

The invention relates to a parking apparatus with left and right longitudinal supports, left and right vertical stanchions extending up from the respective longitudinal supports and a parking platform that can be raised and lowered along the stanchions. More particularly, the parking platform includes left and right carriages with rollers or wheels that move vertically along vertical channels or rails formed in or on the vertical stanchions.

The parking platform is raised and lowered by left and right pairs of articulated levers that cooperate respectively with left and right piston-cylinder assemblies. Each pair of articulated levers includes a base lever having a first end articulated to a rear position on the respective longitudinal support and a second end opposite the first end. Each pair of articulated levers further includes a platform lever having a first end articulated to a position on the parking platform in proximity to the respective vertical stanchion and a second end articulated to the second end of the base lever.

Each of the piston cylinder assemblies includes a cylinder articulated to an upper position on the respective vertical stanchion and a piston articulated to an intermediate position on the platform lever. Movement of the piston into or out of the cylinder causes several related movements of the corresponding articulated lever assembly. More particularly, the free end of the piston that is remote from the cylinder articulates relative to the platform lever; the second end of the platform lever pivots relative to the second end of the base lever; the first end of the platform lever pivots relative to the parking platform and the base lever; and the platform lever effectively folds or unfolds relative to the base lever depending on whether the piston is extended from the cylinder or retracted into the cylinder. In this regard, movement of the piston into the cylinder causes the articulated platform levers to unfold, thereby raising the parking platform along the vertical stanchion. Movement of the piston out of the cylinder causes the articulated lever assembly to fold and thereby moves in the parking platform lower toward the longitudinal supports.

The pivotal connection of the first end of the platform lever to the platform is subject to significant forces due to the combined weight of the parking platform and the vehicle on the parking platform. As a result, a potential failure of this pivotal connection is of concern. Additionally, repair and/or replacement of the pivotally connected components should be carried out at specified intervals, and therefore the pivotal connection desirably is configured to accommodate such replacement.

In view of the criticality of the pivotal connection of the platform lever to the parking platform, the parking apparatus includes a horizontal support tube extending between left and right sides of the parking platform at positions aligned with the vertical stanchions. Left and right inner bearings are mounted respectively in the opposite left and right ends of the horizontal support tube. Each inner bearing has a cylindrical bore extending axially through the inner bearing. Additionally, an aperture extends diametrically into or through a portion of each inner bearing that projects beyond the end of the horizontal tube and one end of the aperture is threaded to accommodate a bolt as explained herein.

A bearing pin has an inner end that is mounted in the cylindrical bore of the inner bearing and an outer end that projects axially beyond the inner bearing. An aperture extends diametrically into or through a portion of the bearing pin that is disposed within the inner bearing. The bearing pin can be rotated about its axis into a position where the aperture extending diametrically into or through the bearing pin aligns with the aperture that extends into or through the inner bearing. A locking bolt then can be inserted through the apertures in the inner bearing and the aperture in the bearing pin for rotationally and axially fixing the bearing pin in the inner bearing. The locking bolt can be threaded to the internal threads formed in the aperture through the inner bearing.

An aperture extends through a position on the platform lever near the first end of the platform lever. The aperture in the platform lever is mounted rotationally over a part of the outer end of the bearing pin and adjacent to the free and of the inner bearing projecting axially beyond the end of the horizontal support tube.

A platform support is mounted to a part of the parking platform that aligns substantially with the corresponding vertical stanchion. An end region of the platform support includes an aperture that is dimensioned to receive a region near the free outer end of the bearing pin so that the first end of the platform lever is disposed pivotally between the inner bearing and the platform support. Additionally, a cylindrical boss projects axially from the platform support at a position aligned axially with the aperture through the platform support. The free and of the bearing pin is supported in the cylindrical boss to provide an additional surface area of contact between the bearing pin and the platform support. The cylindrical boss can be unitary with the platform support or can be a separate component welded integrally with the platform support. In either event, the cylindrical boss provides greater support for the inner bearing, and therefore an enhanced load carrying capacity for the parking platform.

The platform support may include a lubrication port to accommodate an application of lubricating material at the interface between the platform support and the bearing pin.

The free outer end of the bearing pin may have an aperture, at least a portion of which is threaded. A threaded tool can be engaged in the aperture in the free end of the bearing pin to facilitate removal of the bearing pin from the inner bearing for inspection or replacement.

The free end of the bearing pin also may have a transverse or diametric slot to accommodate a flat-ended tool, such as a screwdriver, to rotate the bearing pin into an alignment where the aperture extending diametrically through the inner part of the bearing pin aligns with the aperture in the inner bearing so that the locking bolt can be inserted through the aligned apertures.

### BRIEF DESCRIPTION OF THE DRAWINGS

FIG. 1 is a perspective view of a parking apparatus according to one embodiment of the invention.

FIG. 2 is an enlarged perspective view of a region where the platform lever engages with the parking platform of the apparatus.

FIG. 3 is a perspective view similar to FIG. 2, but without the vertical stanchion and showing the parts of parking platform that engage with the platform lever.

FIG. 4 is a cross-sectional view of the region illustrated in FIG. 3 taken along a diametric plane that includes the rotational axis between the platform lever and the platform.

### DETAILED DESCRIPTION

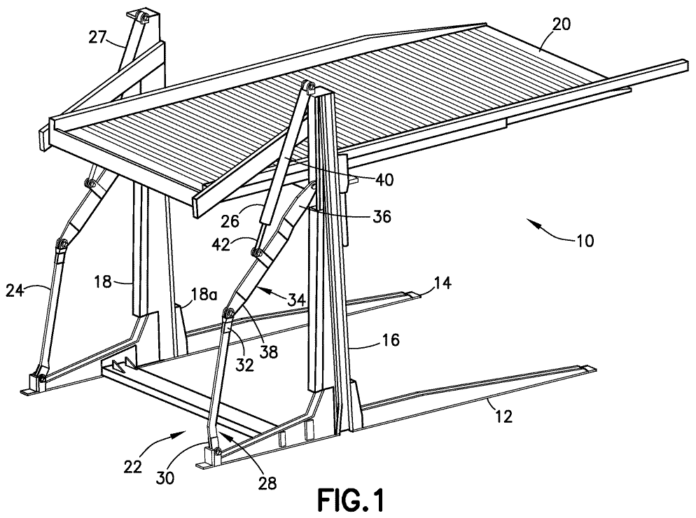

A parking apparatus according to one embodiment of the invention is identified by the numeral 10 in FIG. 1. The parking apparatus 10 includes left and right horizontal supports 12 and 14 to be supported on a floor or ground surface of a parking facility. Left and right stanchions 16 and 18 extend substantially vertically up from the left and right supports 12 and 14. A parking platform 20 is mounted to the stanchions 16 and 18 and can move from an uppermost position, as illustrated in FIG. 1 to a lowermost position where the parking platform is between the left and right supports 12 and 14.

Left and right articulated lever assemblies 22, 24 and left and right piston-cylinder assemblies 26 and 27 are provided respectively on opposite left and right sides of the parking apparatus 10 and operate for moving the parking platform 20 vertically along the left and right stanchions 16 and 18. For simplicity, only the left articulated lever assembly 22 and the left piston-cylinder assembly 26 will be discussed herein, with the understanding that the right articulated lever assembly 24 and the right piston-cylinder assembly 28 are structurally and functionally identical respectively to the left articulated lever assembly 22 and the left piston-cylinder assembly 26.

The articulated lever assembly 22 includes a base lever 28 having a first end 30 articulated to a position near the rear end of the horizontal support 12 and a second end 32 opposite the first end 30. The articulated lever assembly 22 further includes a platform lever 34 having a first end 36 articulated to the parking platform 20 and a second end 38 articulated to the second end 32 of the base lever 28.

The piston-cylinder assembly 26 includes a cylinder 40 pivotally connected to a position near the upper end of the vertical stanchion 16 and a piston 42 having a free or projecting end articulated to an intermediate position on the platform lever 34. Hydraulic forces generate movement of the piston 34 into or out of the cylinder 40 for raising or lowering the parking platform 20.

The weight of the parking platform 20 and a vehicle parked thereon is carried by the pivotal connection of the platform lever 34 to the parking platform 20. The following paragraphs describe a specific embodiment of that pivotal connection to provide enhanced weight-carrying capability, enhanced maintenance and easy replacement.

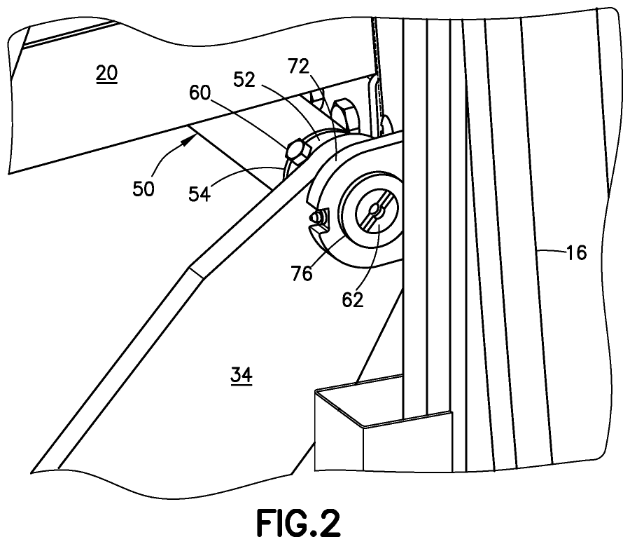

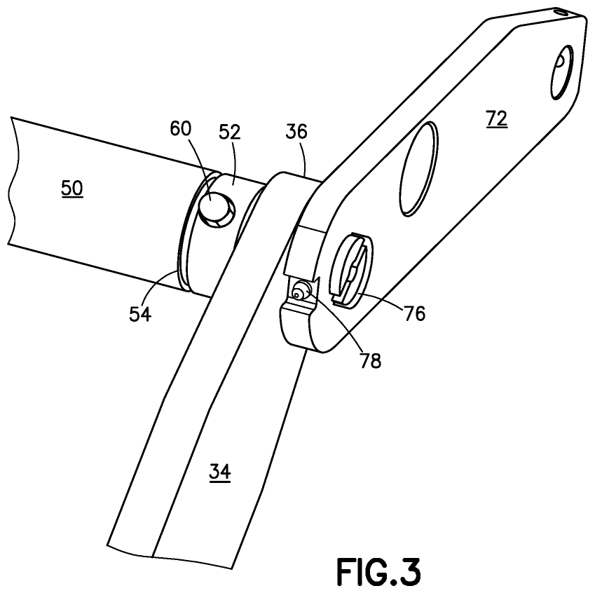

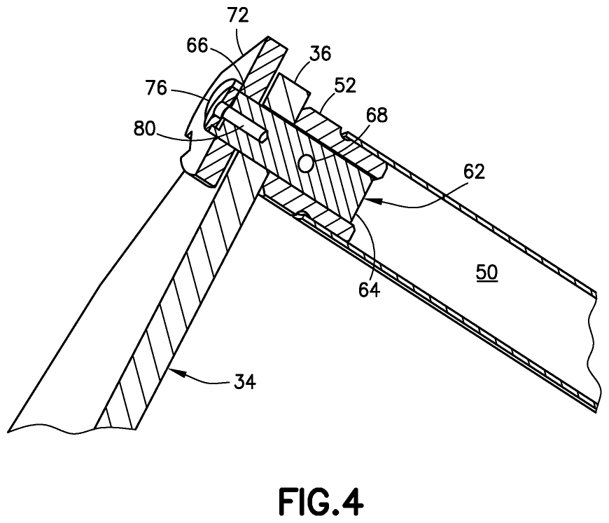

With reference to FIGS. 2-4, the parking apparatus 10 includes a horizontal support tube 50 extending between left and right sides of the parking platform 20 at positions aligned with the vertical stanchions 16 and 18. An inner bearing 52 is mounted in the end 54 of the horizontal support tube 50. The inner bearing 52 has a cylindrical bore 56 extending axially through the inner bearing 52. Additionally, an aperture 58 extends diametrically through a portion of each inner bearing 52 that projects beyond the end 54 of the horizontal support tube 50 and one end of the aperture 58 is threaded to accommodate a locking bolt 60, as explained herein.

A bearing pin 62 has an inner end 64 that is mounted in the cylindrical bore 56 of the inner bearing 52 and an outer end 66 that projects beyond the inner bearing 52. An aperture 68 extends diametrically through a portion of the bearing pin 62 that is disposed within the inner bearing 52. The bearing pin 62 can be rotated into a position where the aperture 68 extending diametrically through the bearing pin 62 aligns with the aperture 58 through the inner bearing 52. The locking bolt 60 then can be inserted through the apertures 58 in the inner bearing 52 and the aperture 68 in the bearing pin 62 for rotationally and axially fixing the bearing pin 62 in the inner bearing 52. The locking bolt 60 can be threaded to the internal threads formed in the aperture 58 through the inner bearing 52.

An aperture 70 extends through a position on the platform lever 24 near the first end 36 of the platform lever 34. The aperture 70 in the platform lever 34 is mounted rotationally over a part of the outer end of the bearing pin 62 and adjacent to the free end of the inner bearing 52 projecting axially beyond the end 54 of the horizontal support tube 50.

A platform support 72 is mounted to a part of the parking platform 20 that aligns substantially with the corresponding vertical stanchion 16. An end region of the platform support 72 includes an aperture 74 that is dimensioned to receive a region near the free outer end of the bearing pin 62 so that the first end 36 of the platform lever 34 is pivotally disposed between the inner bearing 52 and the platform support 72. Additionally, a cylindrical boss 76 projects axially from the platform support 72 at a position aligned axially with the aperture 74 through the platform support 72. The free end of the bearing pin 62 is supported in the cylindrical boss 76 to provide additional surface area of contact between the bearing pin 62 and the platform support 72. The cylindrical boss 76 can be unitary with the platform support 72 or can be a separate component welded integrally with the platform support 72. In either event, the cylindrical boss 76 provides greater support for the inner bearing 52, and therefore an enhanced load carrying capacity for the parking platform 20.

The platform support 72 may include a lubrication port 78 to accommodate an application of lubricating material at the interface between the platform support 72 and the bearing pin 62.

The free outer end of the bearing pin 62 may have an aperture 80, at least a portion of which is threaded. A threaded tool can be engaged in the aperture in the free end of the bearing pin 62 to facilitate removal of the bearing pin 62 from the inner bearing 52 for inspection or replacement. Additionally, the free outer end of the bearing pin 62 can have a diametrically aligned slot that can receive a screwdriver or similar tool to rotate the bearing pin into a position where the aperture 68 in the bearing pin 62 aligns with the apertures 58 in the inner bearing 52 to receive the locking bolt 60.

The additional surface area of contact provided by the combination of the platform support 72 and the cylindrical boss 76 with the bearing pin 62 significantly increases the loadbearing capacity of the parking platform 20, while significantly reducing the possibility of failure and increasing the time required for scheduled maintenance and schedule part replacement. Additionally, the lubrication port 78 facilitates lubrication of these critical loadbearing articulated connections. Furthermore, the threaded aperture 80 can be engaged by a threaded tool to facilitate removal of the bearing pin for inspection, maintenance or replacement.

1. A parking apparatus, comprising:
left and right stanchions extending up from a base;
a parking platform mounted to the left and right stanchions and being movable between lower and upper positions;
left and right lever assemblies, each of the lever assemblies having inner surfaces facing toward one another and outer surfaces facing away from one another, each of the lever assemblies further including a first lever with an upper end having an articulated connection to the parking platform and a second lever with a lower end having an articulated connection to the base;
means for moving the left and right lever assemblies between folded conditions where the parking platform is in the lower position and an unfolded conditions where the parking platform is in the upper position, wherein:
the articulated connection of the parking platform to the upper end of the first lever in each of the left and right lever assemblies comprises: an inner bearing rotatably mounted adjacent the inner surface of the respective lever assembly, an outer bearing mounted adjacent a surface of the parking platform facing away from the inner bearing, and a pin engaged with the inner and outer bearings and passing through the upper end of the respective first lever.

2. The parking apparatus of claim 1, further comprising an engaging member passing radially into the inner bearing and engaged with the pin to prevent rotation between the inner bearing and the pin.

3. The parking apparatus of claim 2, wherein the engaging member is a bolt threadedly engaged in a radially aligned aperture in the pin.

4. The parking apparatus of claim 3, wherein the bolt has a non-circular head exposed radially outward from the inner bearing.

5. The parking apparatus of claim 3, wherein the parking platform comprises a rigid tube having a opposite left and right ends telescoped over ends of the inner bearings, the left and right ends of the rigid tube being spaced from the inner surfaces of the respective lever assembly.

6. The parking apparatus of claim 5, wherein each of the inner bearings has an outer end portion projecting beyond the opposite left and right ends of the rigid tube, the outer end portions of the inner bearings being cross-sectionally larger than an inner cross-sectional dimension of the inner tube to limit telescoped movement of the rigid tube over the inner bearings.

7. The parking apparatus of 1, further comprising a lubrication port extending through a part of the parking platform outward from the outer surface of the respective lever assembly and communicating with an outer circumferential surface of the pin for delivering a lubricant to surfaces of the pin that pass rotatably through the first lever.

8. The parking apparatus of claim 1, wherein the parking platform has left and right carriages with wheels rotatably engaged respectively with the left and right stanchions, the outer bearings being mounted respectively to the carriages of the parking platform.
